(19) United States
(12) Patent Application Publication
(10) Pub. No.: US 2008/0054635 A1
(43) Pub. Date: Mar. 6, 2008

(54) High pressure fluid connector and seal

(75) Inventors: Terence E. Skiba, Ocala, FL (US); Randy C. Stanley, Ocala, FL (US); Robert Williamson, Bloomfield Hills, MI (US); Herb Lemaster, Marion County, FL (US)

Correspondence Address: DAYCO PRODUCTS, LLC, 1 PRESTIGE PLACE, MIAMISBURG, OH, 45342, US

(73) Assignee: DAYCO PRODUCTS, LLC

(21) Appl. No.: 11/514,137

(22) Filed: Aug. 31, 2006

(51) Int. Cl. F16L 33/18

(52) U.S. Cl. 285/347; 285/332.1; 285/332.2; 285/332.3

(57) ABSTRACT

An improved tubular system for transporting a fluid at high temperature and high pressure is described wherein the improved tubular system includes a first rigid tubular segment having an axial bore including a male connector end fitting portion terminating at a proximal end thereof, the male connector end fitting portion comprising a radial shoulder surface having an outer circumferential rim, the radial shoulder surface being perpendicular to the longitudinal axis of the first rigid tubular segment, the male connector end fitting portion further comprises an end fitting body section exhibiting a frusto conical configuration slpingly extending a specified length from the circumferential rim toward the proximal end of the tubular segment; a seal member fixed on a tubular surface of the first tubular member at the terminus of the end fitting body section, with the proviso that the seal member is fixed on the tubular surface in the absence of a groove in the first tubular surface; and a second rigid tubular segment having an axial bore for transporting fluid at high temperature and high pressure, the second rigid tubular segment including a female connector end fitting portion terminating at a proximal end thereof, the female connector end fitting portion comprising an opening defining an inner cavity, the inner cavity exhibiting a tapered.

### BACKGROUND OF THE INVENTION

The present invention relates generally to tubular members and particularly to tubular members for conveying fluids at high pressures and high temperatures. More particularly, the invention relates to the connection of a tubular member to other fluid conveying members such as another tubular member or other devices for use in conveying a liquid, particularly, in an automotive system, e.g., power steering systems, power brake systems, air conditioner systems, etc.; and to O-ring seals which are functional at high pressures and temperatures, wherein the O-ring seals are employed in the absence of a groove in the tubular member for receiving the O-ring. The tubular members and the O-rings of the invention are particularly suitable in automotive power steering systems.

There are numerous end fitting systems for joining tubular conduits to each other, or to form a connection between a tubular conduit and a device through which fluids are transported under high pressure and high temperature. The problem with conventional couplings which transport fluids under high pressures and temperatures are that they are prone to leaks resulting in the loss of fluid which can be hazardous as well as expensive. In recent years numerous regulartions have been imposed upon manufacturing industries in general, and upon the automotive industry in particular, which are inteneded to reduce the amount of potentially harmful contaminates from being released into the environment. Traditionally, fluid connectors having better surface finishes and tighter tolerances are manufactured in order to minimize the potential for leaks. However, the smoother surfaces and closer fit tolerances have not been entirely adequate to eliminate the problem.

Typically, elastomeric O-rings are employed to seal fluid connector systems against leaks where fluid are transported at elevated pressure. However, such elastomeric O-ring seals are most effectively used in applications where the pressure is not expected to exceed about 700 psi. At greater pressures, special materials and sealing configurations are required. Furthermore, O-rings are placed in grooves around the tubular structure of the connector which limits their position to the prior placement of the groove formed in the tubular structure. The groove on the tubular structure surface is formed by “rolling” which has been found to cause the material of the tubular structure to be thin on the backside of the groove causing the backslide of the groove to be susceptible to forming cracks when side loaded. Accordingly, there is a need in the industry for an improved fluid transporting system which is not susceptible to cracking, and to sealing members adapted to be used in the absence of a groove for accepting the sealing member, wherein the fluid transporting system and sealing member are useful for connecting one fluid connector to another fluid connector such that the potential of leaking is minimized, particularly, in automotive fluid transporting systems such as power steering systems which perate at higher pressures and temperatures than typically encountered, and sealing members which are not susceptible to cracking.

### SUMMARY OF THE INVENTION

It is an object of the present invention to provide an imporved end fitting configuration for joining a connective end of a first tubular conduit member to another conduit device for conveying fluids such as a second tubular conduit member, a housing member, or the like which is configured to receive the connective end of the first tubular conduit member so that the two members are joined together.

It is another object of the present invention to provide an improved end fitting connection which will reduce the risk of leaking fluids being transported therethrough.

It is still another object of the present invention to provide an end fitting connection having an imporved life expectancy.

It is yet another object of the present invention to provide an end fitting connection which employs a seal member such as an O-ring, which is capable of withstanding high pressure and high temperatures.

In accordance with one embodiment of the invention, a tubular conduit for use in the automotive industry for transporting a fluid includes a first male connector end fitting segment having a frusto conical shape. A second fluid connector member includes a female connector end fitting configuration having an inner tapered surface which is complementary to the frusto conical end of the the first male connector end fitting, for receiving the frusto conical end of the first male connector end fitting such that the outer surface of the male end of the first connector sealingly mates with the inner surface of the female end of the second connector.

In accordance with another embodiment of the invention, a grooveless seal member such as an O-ring or sleeve, hereafter referred to simply as an O-ring, is press fit around the outer surface of the first fluid connector segment without the benefit of a groove into which the O-ring is received. The O-ring is forced against the taper of the male end of the first connector where it remains in place to further insure that the connector system does not leak. The O-ring is designed with a flat inner surface and a flat outer surface which provides the O-ring with the square surfaces that are needed to prevent the O-ring from premature wear.

The first tubular conduit segment of the invention is sealingly connected to the second tubular conduit segment by any means or apparatus commonly employed in the art to connect one tubular conduit to another tubular conduit. For example, the connector means may be a quick-connect/quick-disconnect connector or an externally threaded coupler on one tubular segment and an internally threaded coupler on the other tubular segment.

### DESCRIPTION OF THE DRAWINGS

FIG. 1 is an exploded cross-sectional longitudinal view of two prior art conduits for forming a connection therebetween;

FIG. 2 is a cross-sectional longitudinal view of the prior art conduits of FIG. 1 joined together;

FIG. 3 is an exploded cross-sectional longitudinal view of two conduits of the present invention for forming a connection therebetween;

FIG. 4 is a cross-sectional longitudinal view of the conduits of the present invention joined together; and

FIG. 5 is a cross-sectional side view of a seal member of the present invention.

### DETAILED DESCRIPTION OF THE INVENTION

In accordance with the invention, a male conduit member is configured to be connectedly disposed inside a corresponding female conduit member such that the two members are in a close fitting relationship with each other to prevent fluid from leaking from the connection, In order to further insure that the fluid does not leak from the connection, a grooveless O-ring or sleeve is press fit onto the outer surface of the male conduit and forced against the smaller end of the tapered frusto conical end of the male connector.

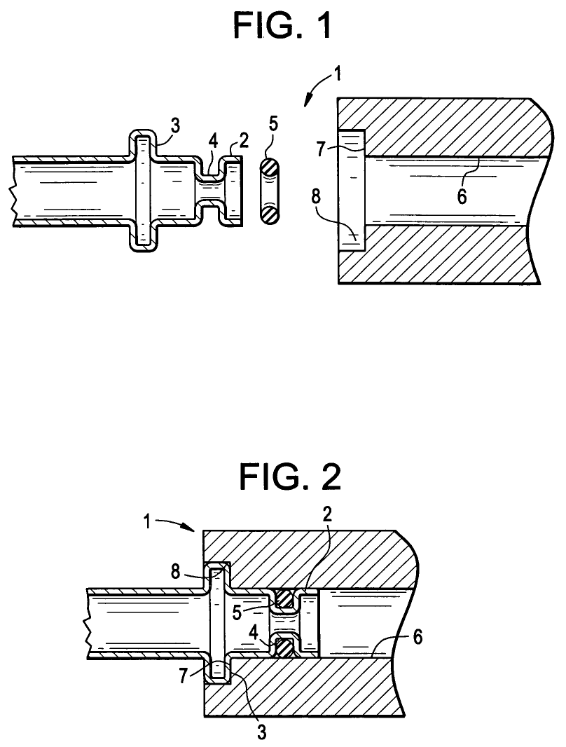

Referring to the drawings, FIGS. 1 and 2 illsutrate a prior art connector 1 which includes a first tubular member 2 having an annular shoulder 3 extending circumferentially around the first tubular member 2. The first tubular member 2 further includes a recessed groove 4 extending circumferentially around the tubular member 3 and forming a specified distance from the annular shoulder 3. The recessed groove 4 is configured to have a specified depth for receiving and retaining an elastomeric O-ring 5. A second conduit 6 includes a recessed ridge 7 and a cavity 8. The first tubular member 2 is inserted into the second conduit 6 to a point where the annular shoulder 3 abuts the recessed ridge 7. Typically, the circumferential recessed groove in the prior art connector (specifically, the male connnector) is formed by roll grooving a circumferential slot into the tubular part of the connector. Roll grooving causes the material from which the connector is made, to weaken thereby providing a groove which is formed in a non-uniform manner, i.e., one part of the groove is typically thinner than the rest of the groove. It has been found that the non-uniformity of the groove causes the connector to crack, generally at the bottom of the groove.

A particularly advantageous aspect of the fluid connector system of the present invention is that the male portion of the connector can be manufactured using a single machine whereas two machines are required to form the male portion and the groove of the prior art fluid connector systems.

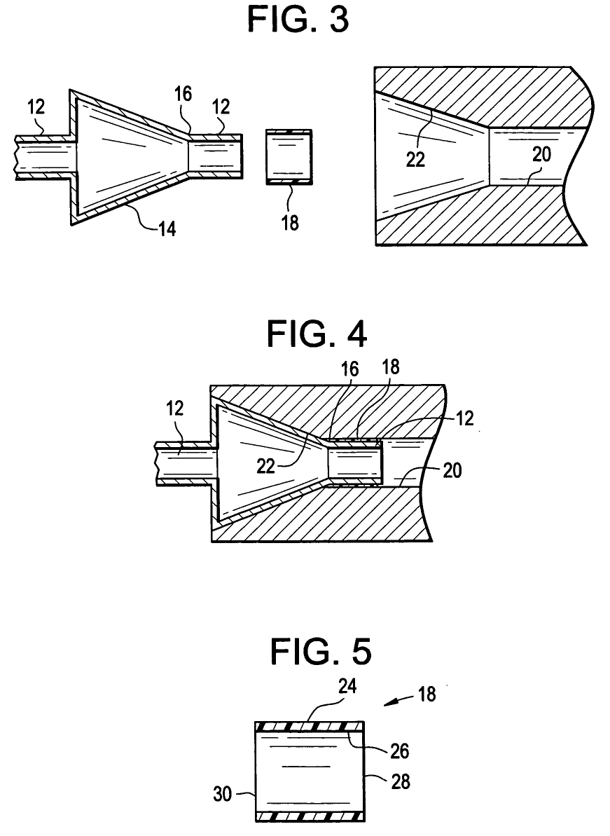

FIGS. 3 and 4 illustrate a connector 10 of the present invention which includes a first tubular segment 12 having an annular shoulder 14 extending perpendicularly outward from the first tubular member 12. The annular shoulder 14 gradually extends toward the first annular connector member 12 such that it exhibits a frusto conical configuration such that the frusto conical ocnfiguration has an angular configuration of about 20 to 40°, more preferable, about 25 to 35° and, most preferably about 28-32° with respect to the longitudinal axis of the connector. A frusto conical configuration having an angular configuration of about 30° has been found to provide a satisfactory connector end. The first tubular member 12 exhibits a smooth annular surface 14 extending circumferentially from the terminus 16 of the frusto conical configuration. It has been found that the configuration of the present fluid connectors provides a more robust connection from a flex/loading standpoint that the prior art connections.

In accordance with the present invention, the tubular portion of the first fluid connector 12, does not contain a groove. The O-ring 18 having a square profile and a flat inner surface is press fit onto the annular suface 14 of the connector member 12 and forced against the terminus 16 of the frusto conical configuration. The first annular connector 12 is then inserted into an open end of a second annular connector member 20, the open end of the second connector member 20 is defined by a tapered surface 22 which corresponds to the frusto conical configuration of the first connector member 12. Upon being inserted into the second connector member 20, the frusto conical configuration of the first connector member 12 mates with the tapered surface 22 of the second connector member 20 to form a seal between the two connector members.

FIG. 5 is a side view of the seal member of the present invention, wherein the seal member or O-ring 18 has a flat exterior surface 24, a flat interior surface 26, a flat front surface 28 and a flat back surface 30.

The first and second conduit segments of the present invention may be made from any of the rigid materials known in the art for the manufacture of tubular members. For example, the conduit segments of the present invention may be formed from metals such as stainless steel, brass, copper, aluminum and alloys thereof, ceramic materials, or polymeric materials. O-rings are typically made from elastomeric materials and, as such, are not considered to be effective at temperatures greater than about 700° psi. Furthermore, such O-rings are intended to be employed in grooves which maintain the O-ring in a stable orientation. With respect to the present invention, the O-ring is intended to be utilized at high pressures up to about 2500 psi and at temperatures greater than about 300° F. Typically, the oil temperature in a power steering unit will be about 302° F. and the oil pressure will reach about 2500 psi or more. In order to meet the criteria for use in automotive applications, particularly, for use in power steering systems, power brake systems and transmission assemblies, the O-ring must be constructed of a material which can withstand the extreme temperatures and pressures of such systems. Accordingly, the O-rings of the present invention comprise thermoplastic materials such as fluoropolymers, e.g., tetrafluoroethylene, fluorinated copolymers and terpolymers of ethylene and propylene, nylon, and the like. Teflon, a registered trademark of DuPont, is a fluorocarbon material available from DuPont, and has been found to be particularly effective in the formation of the O-rings of the present invention. Alternative materials for use as the O-ring include metals such as brass, stainless steel, and the like.

While the present invention has been fully described and illustrated herein, it is to be understood that certain variations, changes and modifications may be made to the invention without departing from the spirit and scope of the invention as defined by the appended claims.

What is claimed is:

1. In a tubular conduit for transporting a fluid at high temperature and high pressure through an automotive fluid transporting system, the improvement wherein the tubular conduit comprises:
a first rigid tubular segment having an axial bore through fluid is conveyed, said first rigid tubular segment including a male connector end fitting portion terminating at a proximal end thereof, said male connector end fitting portion comprising a radial shoulder surface having an outer circumferential rim, said radial shoulder surface being perpendicular to the longitudinal axis of said first rigid tubular segment, said male connector end fitting portion further comprises an end fitting body section exhibiting a frusto conical configuration slopingly extending a specified length from said circumferential rim toward said proximal end of said tubular segment;
a seal member fixed on a tubular surface of said first tubular member at the terminus of said end fitting body section, with the proviso that said seal member is fixed on said tubular surface in the absence of a groove in said first tubular surface; and
a second rigid tubular segment having an axial bore through which fluid is transported, said second rigid tubular segment including a female connector end fitting portion terminating at a proximal end thereof, said female connector end fitting portion comprising an opening defining an inner cavity, said inner cavity exhibiting a tapered surface corresponding to the outer surface of said frusto conical end fitting body section, wherein said female connector end fitting portion is adapted to accept said frusto conical body section.

2. The tubular conduit of claim 1 wherein said frusto conical male end fitting connector exhibits a tapered surface, said tapered surface having an angle of about 20 to 40° with respect to the longitudinal axis of said first tubular member.

3. The tubular conduit of claim 1 wherein said male connector end fitting is made of metal.

4. The tubular conduit of claim 3 wherein said metal is stainless steel.

5. The tubular conduit of claim 1 wherein said female connector end fitting is made of metal.

6. The tubular conduit of claim 5 wherein said metal is stainless steel.

7. The tubular conduit of claim 1 wherein said O-ring is made of a thermoplastic material or a metal.

8. The tubular conduit of claim 7 wherein said O-ring is made of a thermoplastic material selected from the group consisting of fluoropolymer, polyamide, polyimide, polyester, polyether, polyurethane, and mixtures thereof.

9. The tubular conduit of claim 8 wherein said thermoplastic material is a fluoropolymer.

10. The tubular conduit of claim 9 wherein said fluoropolymer is tetrafluoroethylene.

11. The tubular conduit of claim 7 wherein said O-ring is a metal selected from the group consisting of brass, stainless steel, aluminum, and copper.

12. The tubular conduit of claim 1 wherein said assembly is used in transporting power steering fluid in an automotive power steering system.

13. The tubular conduit of claim 1 wherein said first tubular member comprises securing means for securing said first rigid tubular section to said second rigid tubular section.

14. The tubular conduit of claim 13 wherein said securing means is one of a quick-connect/quick-disconnect coupler, or an externally threaded coupler on one of said first tubular segment and said second tubular segment, and an internally threaded coupler on the other of said first tubular segment and said second tubular segment.

15. A method for coupling a first rigid tubular segment to a second rigid tubular segment in an automotive fluid transporting system wherein said fluid is transported at high temperature and high pressure, said method comprising:
providing a first rigid tubular segment having an axial bore through which fluid at high temperature and high pressure is transported, said first tubular segment including a male connector end fitting portion at a proximal end thereof, said male connector end fitting portion comprising a shoulder surface having an outer circumferential rim, said shoulder portion being perpendicular to the longitudinal axis of said male connector end fitting portion, said male connector end fitting portion exhibiting a frusto conical configuration extending a specified length from said circumferential rim toward a proximal end of said male connector end fitting portion, said frusto conical configuration terminating at said specified length of said male connector end fitting portion;
press fitting an O-ring seal member onto said tubular surface at the terminus of said frusto conical configuration, with the proviso that said O-ring is fixed on said tubular surface in the absence of a groove for said O-ring in said tubular surface; and
providing a second rigid tubular segment having an axial bore through which fluid at high pressure and temperature is transported, said second tubular segment comprising a female connector end fitting portion at a proximal end thereof, said axial bore having an opening defining an inner cavity exhibiting a tapered surface corresponding to the tapered surface of said outer surface of said frusto conical configuration of said male connector end fitting portion of said first tubular connector segment, said inner cavity adapted to accept said male connector end portion of said first tubular member; and
inserting said male connector end fitting portion into said female connector end fitting portion, wherein said frusto conical configuration of said male connector end fitting couples with said tapered surface of said female connector end fitting to provide a leak free seal therebetween.

16. The method of claim 16 wherein said frusto conical surface exhibits an angle of about 20 to 40° with respect to the longitudinal axis of said first tubular segment.

17. The method of claim 16 wherein said first rigid tubular segment is made of stainless steel.

18. The method of claim 16 wherein said second rigid tubular segment is made of stainless steel.

19. The method of claim 16 wherein said O-ring is made of a thermoplastic material or metal.

20. The method of claim 20 wherein said O-ring is made of a thermoplastic material selected from the group consisting of fluoropolymer, polyamide, polyimide, polyester, polyether, polyurethane, and mixtures thereof.

21. The method of claim 21 wherein said thermoplastic material is a fluoropolymer.

22. The method of claim 22 wherein said fluropolymer is tetrafluoroethylene.

23. The method of claim 20 wherein said O-ring is made of metal.

24. The method of claim 24 wherein said metal is stainless steel.

25. A seal member for use in seating a first tubular segment to a second tubular segment in a fluid transport system to prevent leaking therebetween, said seal member comprising an annular outer surface, an annular inner surface, a first side surface, and a second side surface, said first side surface and said second side surface being parallel with respect to each other and perpendicular with respect to each of said annular outer surface and said annular inner surface, said seal member exhibiting an axial cross-section having a substantially rectangular configuration, wherein said seal member is configured to be fixed on an outer surface of one of said first tubular segment and said second tubular segment in the absence of a groove therein for receiving said seal member.

26. The seal member of claim 26 wherein said seal member is an O-ring made from a thermoplastic material or a metal material.

27. The seal member of claim 27 wherein said O-ring is made from a thermoplastic material selected from the group consisting of fluoropolymer, polyamide, polyimide, polyester, polyether, polyurethane, and mixtures thereof.

28. The seal member of claim 28 wherein said thermoplastic material is a fluoropolymer.

29. The seal member of claim 29 wherein said fluoropolymer is tetrafluoroethylene.

30. The seal member of claim 30 wherein said O-ring is made from a metal selected from the group consisting of brass and stainless steel.
